(19) United States
(12) Patent Application Publication
(10) Pub. No.: US 2020/0071889 A1
(43) Pub. Date: Mar. 5, 2020

(54) APPARATUS AND METHOD FOR MAXIMIZING RAP CONTENT IN PAVING

(71) Applicant: Brian H. Ramsey, Red Bluff, CA (US)

(72) Inventor: Brian H. Ramsey, Red Bluff, CA (US)

(21) Appl. No.: 16/548,321

(22) Filed: Aug. 22, 2019

Related U.S. Application Data
(60) Provisional application No. 62/722,740, filed on Aug. 24, 2018.

(51) Int. Cl. E01C 19/10; B01F 3/10; B01F 3/08; B01F 9/06; B01F 15/06

(52) U.S. Cl. CPC E01C 19/1036; B01F 3/10; B01F 3/088; B01F 3/0853; B01F 2215/0063; B01F 15/066; E01C 19/1004; B01F 2015/062; B01F 9/06

(57) ABSTRACT

An asphalt production apparatus (APA) (14) and process for utilizing a substantial fraction of RAP (Recycled Asphalt Product) (10) in producing a renewed amalgam (12) for paving. The APA (14) is formed about an inclined central axis (18) and includes core components (16), namely: a non-rotating ignition cylinder (24); a rotating mixing drum (26) having a hollow interior (16) with radially spaced combustion tubes (52) longitudinally extending therethrough; and a stationary capture trap (28) for receiving renewed amalgam (12) and redirecting some spent gases (54) back through the a mixing drum (26) in a second pass. The ignition cylinder (24) receives combustion fuel (32) delivered to an igniter (34) and directs flaming gas (36) through the combustion tubes (52) at a flow rate such that the flaming gas (36) becomes spent gases (54) within the tubes (52) short of the capture trap (26) and no flaming gas (36) contacts RAP (10) in the interior of the mixing drum (26).

This is a non-provisional application claiming priority from provisional U.S. application No. 62/722,740, by the same inventor, filed 24 Aug. 2018.

### TECHNICAL FIELD

The present invention relates generally to methods and materials for road construction and more specifically for asphalt production and recycling.

### BACKGROUND ART

A principal form of road and platform paving involves the use of asphalt. Asphalt is a heated blend of gravel, sand, and heavy oil which can be readily applied to areas, flattened, and will then cool to provide a usable and stable surface over which vehicles can travel. Although asphalt has a limited usable life-span, it has an immense utility. Virgin asphalt, prepared only form the above ingredients, is usually utilized in what is generally referred to as Hot Mix Asphalt (HMA).

When asphalt has reached the end of is useful time span, or when it is removed to make way for other projects, there is a residue which is often just stored or discarded. These “grindings” can be slightly toxic to the environment and take up space. However, this residue has the potential for reuse, in that it may be reprocessed and reconstituted for future project. This is material referred to as Recycled Asphalt Products (RAP). Current techniques have permitted limited amounts of granulated RAP to be blended in with virgin asphalt for additional use. Unfortunately there are obstacles which have heretofore severely limited the amount of RAP which can be included in the mix.

A problem with RAP is that various components of the RAP grindings produce a “blue smoke” if heated above a threshold temperature (around 270 degrees Fahrenheit-132 degrees Celsius) and the problem also occurs when the RAP is exposed to combustion gases utilized to heat the ingredients. This temperature and these flame parameter may frequently be exceeded in preparing the prior art asphalt amalgam. Various regulations prohibit creation of byproducts such as “blue smoke” and this limits the utility of putting more than about 30% of RAP into the total amalgam in current apparatus.

Since using higher percentages of RAP in the renewed amalgam results in lower material costs and also has significant environmental benefits, improvements in techniques and equipment are highly desirable.

### DISCLOSURE OF INVENTION

Accordingly, it is an object of the present invention to provide a method and apparatus to process high percentages of RAP into renewed asphalt amalgam in a safe and environmentally friendly manner.

Another object of the invention is to provide an asphalt production apparatus utilizing conductive heat transfer to the RAP from gas combustion tubes formed on the interior of a rotating mixing drum with the combustion tubes being isolated from the RAP while flaming gases exist.

A further object of the present invention is to provide an apparatus for providing second pass heating to the RAP by returning spent combustion gases through the mixing drum.

Yet another object of the invention is to provide combustion tubes of sufficient length that all fuel consumption is completed within the combustion tubes and only spent gases are returned in a second pass.

Another object of the invention is to provide mixing drum interior where the RAP is never put into contact with flaming gases.

A further object of the present invention is to provide an apparatus where the second pass spent gases are ultimately delivered to an exhaust duct in an environmentally friendly manner.

Briefly, one preferred embodiment of the present invention is an asphalt production apparatus having inventive core components specifically adapted to process very high percentages of (or exclusively) RAP input in the production of renewed amalgam asphalt for use in paving processes. The core components include a stationary ignition cylinder, an elongated mixing drum, and a specialized capture trap. The ignition cylinder and capture trap are stationary while the mixing drum rotates. Combustion fuel and pressurized air are fed into and ignited in the ignition cylinder to produce flaming gases which are propelled into combustion tubes radially spaced on the interior surface of the mixing drum, with combustion being completed in the combustion tubes. RAP is supplied directly into the rotating mixing drum through RAP intake ports spaced near the upper end of the drum. The RAP will be conductively heated to a predetermined temperature by contact with the exterior surfaces of the combustion tubes as the RAP is gradually fed through the inclined rotating mixing drum to the capture trap, becoming a renewed amalgam by the end of the journey. The renewed amalgam gravitationally enters the capture trap and is propelled by the rotating tube extension to a return chute for delivery to paving projects. Spent combustion gases from the open ends of the tube extensions are redirected by the capture trap in order to make a second pass back through the mixing drum, adding additional heat to the RAP in passing, to ultimately exit through a shell-exhaust duct.

The process of the present invention can be described as including the following steps:

A. Positioning the core components of the asphalt production apparatus (APA), in an inclined orientation about a longitudinal central axis from an upper intake end to a lower outflow end where the mixing drum mates with the capture trap; B. Initiating rotation of the mixing drum to a predetermined rotation rate and ignite combustion gas in the ignition cylinder to preheat the mixing drum by propelling flaming gas through a series of radially arrayed combustion tubes on the interior surface of the mixing drum until a predetermined optimal temperature is achieved; C. Delivering crushed recycled asphalt product (RAP) into the rotating mixing drum by activating a RAP hopper having a dispensing funnel aligned with radially aligned RAP input ports on the mixing drum, such that the RAP conductively abuts against successive combustion tubes as the mixing drum rotates and the RAP is gradually propelled by gravity toward the capture trap, with additional heating being provides by post-combustion spent gases returned though the mixing drum from the capture trap, with a minimal injection of oil in the lower portion of the passage of the RAP downward through the mixing drum to convert the heated RAP into the desired renewed amalgam by the end of the passage; and D. Collecting the heated renewed amalgam in the capture trap, so the rotation of the mixing drum causes the tube extensions to carry the amalgam to the return chute for delivery to transport units for use in paving, while the predominant portions of the spent gases are deflected upward by the back wall and forced back through the mixing drum by the pressurized air for a second pass through the drum to exit via the shell-exhaust duct.

An advantage of the present invention is that it provides a process and apparatus for making maximal use of RAP in creating usable renewed amalgam asphalt for construction processes,

Another advantage of the invention is that the renewed amalgam is produced without ever exposing the RAP directly to flaming gas, thus avoiding the dangers of “blue smoke”.

Yet another advantage of the present invention is that the RAP is introduced to the rotating mixing drum through RAP intake ports situated downstream from the ignition chamber, to immediately encounter preheated combustion tubes.

Still another advantage of the present invention is that all fuel consumption is completed within the elongated combustion tubes such that only spent gases are returned through the mixing drum in a second pass, further providing thermal energy to the RAP and renewed amalgam.

Another advantage of the present invention is that only a minimal amount of additional oil is need for addition to the RAP in the mixing drum in order to form the desired renewed amalgam.

These and other objects and advantages of the present invention will become clear to those skilled in the art in view of the description of the best presently known mode of carrying out the invention and the industrial

applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. A. (prior art) is a side view of a typical asphalt production apparatus, showing typical associated components;

FIG. 1 is rear perspective view of the preferred embodiment of the asphalt production apparatus of the present invention;

FIG. 2. is a fanciful illustration of the ignition cylinder and the mixing drum elements of the present invention;

FIG. 3 is a left side elevational view of the ignition cylinder, cone segment, and mixing drum of the present invention;

FIG. 4 a rear view of the mixing drum of the presently preferred embodiment of the invention;

FIG. 5. is a side elevational view of the cone segment of the invention;

FIG. 6. is a front view of the capture trap component of the present invention;

FIG. 7 is a side view of the preferred embodiment of the capture trap as installed at the outflow end of the mixing drum; and

FIG. 8 is a fanciful cross sectional view of the core components, showing the pathways of the various material components therethrough;

### BEST MODE FOR CARRYING OUT THE INVENTION

The present invention is an apparatus and method for maximizing RAP (Recycled Asphalt Products) 10 content in paving materials. The method results in a renewed amalgam 12 which is as effective as virgin asphalt while having a RAP content approaching one hundred percent.

The asphalt production apparatus (APA) of the present invention is referred to by the general reference character 14 in the drawings and description. The APA 14 is a system for heating and preparing the desired renewed amalgam 12 with predominately or exclusively RAP 10 and with minimal harmful or prohibited byproducts such as “blue smoke”. The APA 14 includes several prior art elements but includes a group of core components 16 forming the essence of the present invention. The core components 16 are adapted to rest and rotate in a support cradle 17 (see FIG. A).

Various structures and devices shown in the drawings, such as the rolling truck bed are for pre installation purposes and are not a part of the finished in the operational invention.

A prior art system for making virgin asphalt is illustrated in FIG. A (prior art) to show a similar entire apparatus structure with a prior art version of core components. This system includes auxiliary operational elements such as the support cradle 17, not specific to the invention, which are further described below in relation to their purposes.

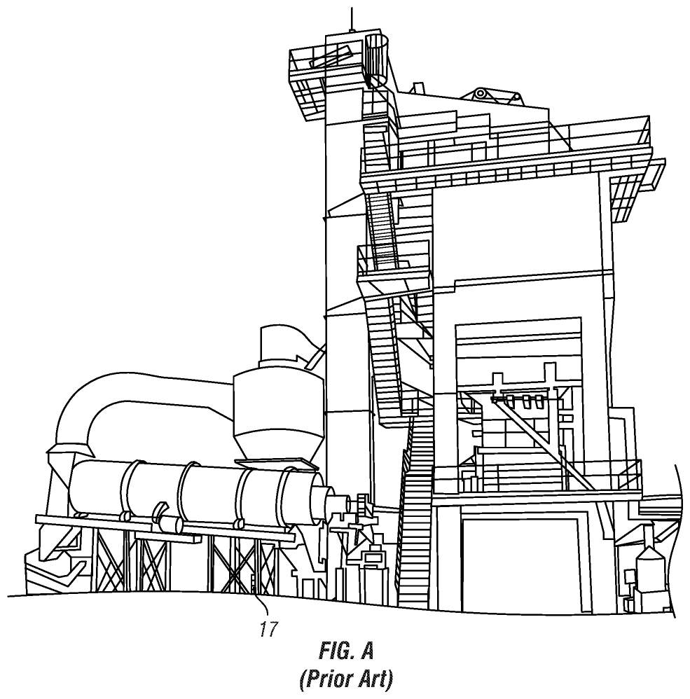

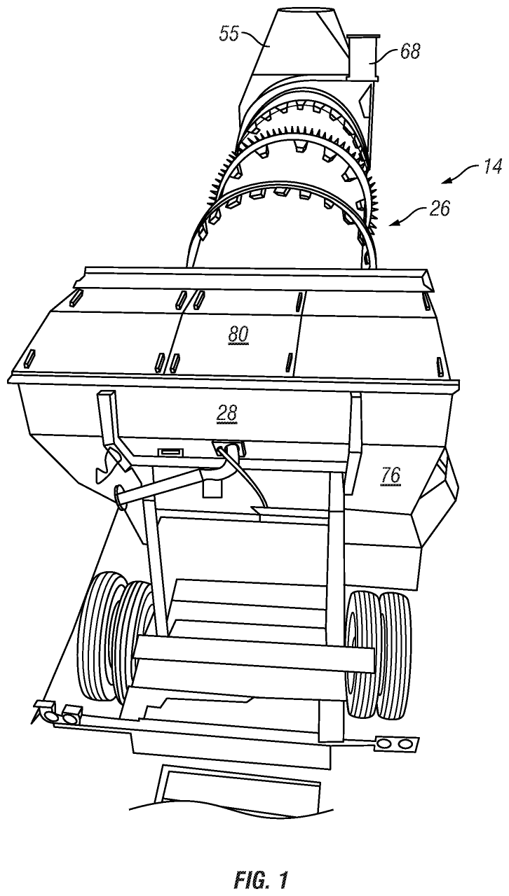

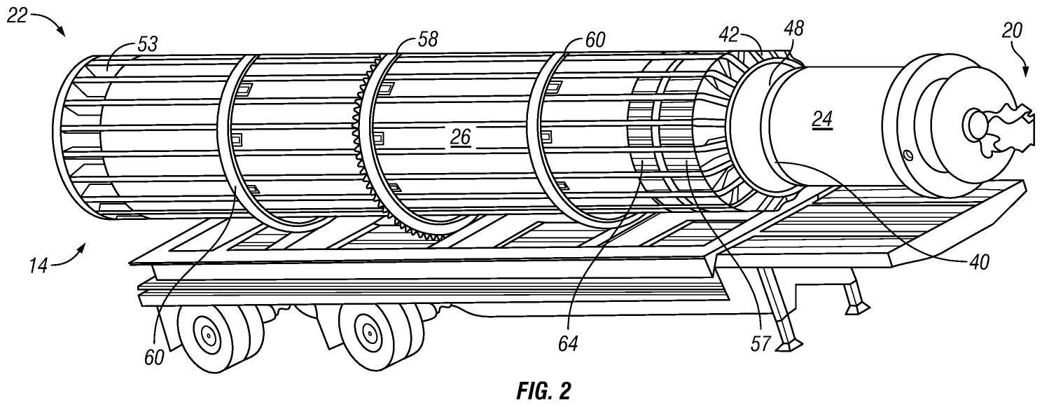

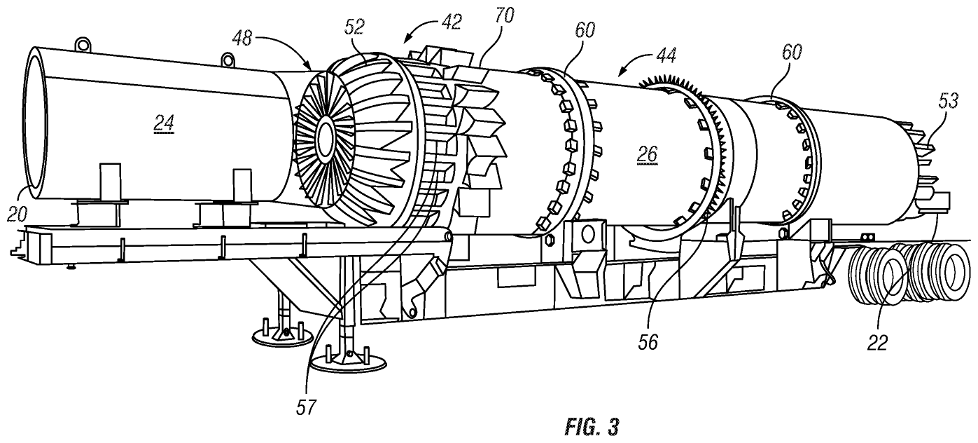

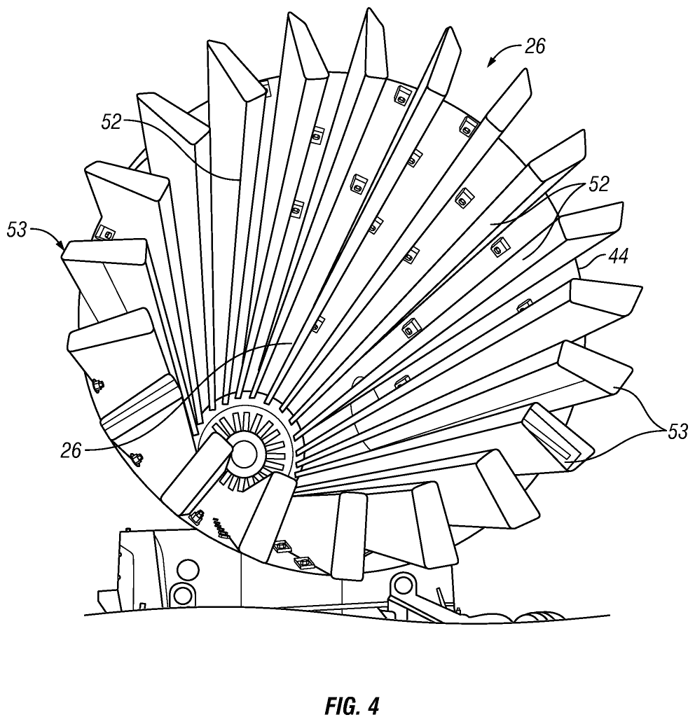

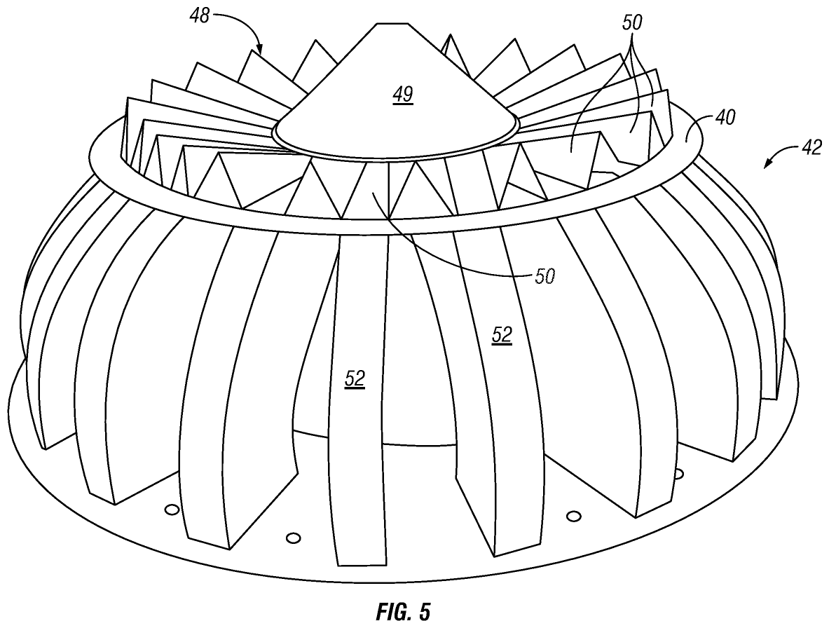

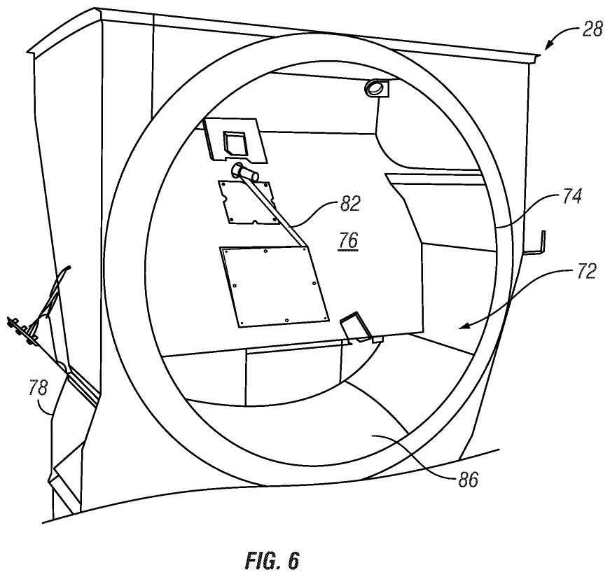

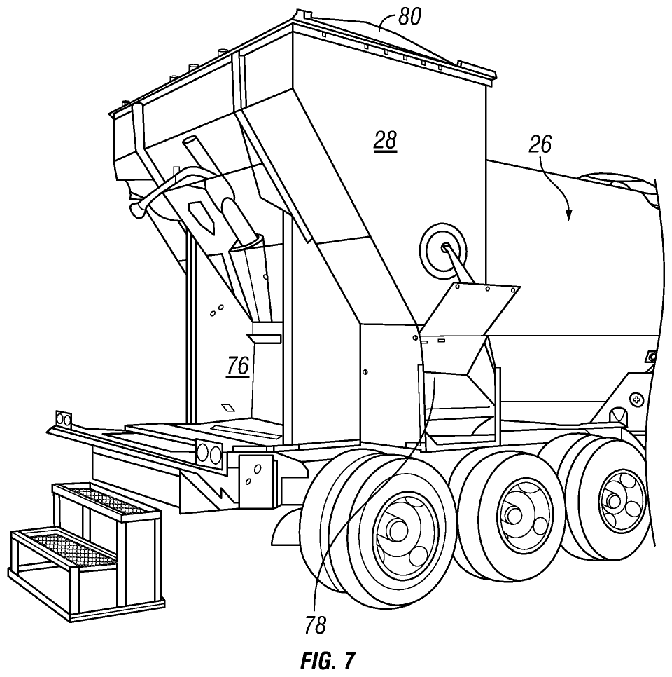

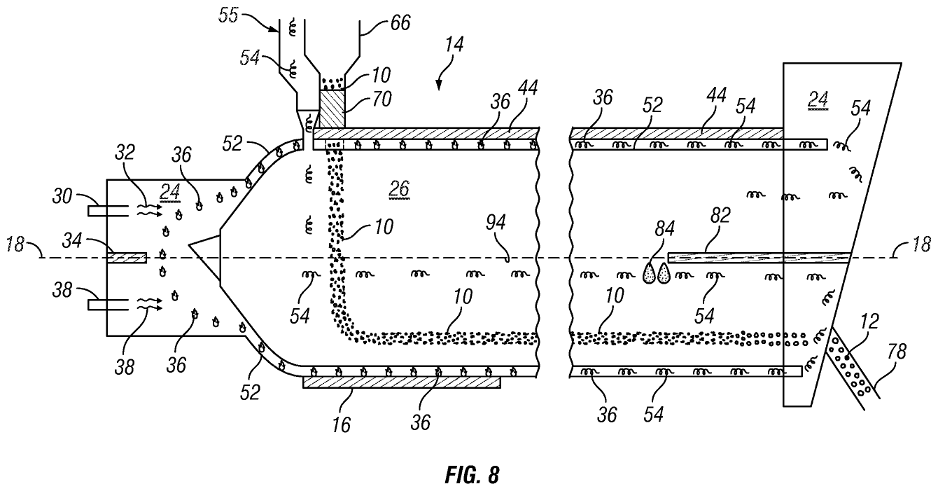

In one preferred embodiment of the invention illustrated in FIGS. 1 through 8, the core components 16 are shown in a various views. The core components 16 are generally radially symmetrical about an axial longitudinal axis 18. The central axis 18 is oriented slightly downward at an angle of about five degrees, from an intake end 20 to an outflow end 22 in order to facilitate movement of the RAP 10 as it passes therethrough.

The core components 16, which are unique to the present invention APA 14, include, beginning at the intake end 20: an ignition cylinder 24; a mixing drum 26; and a capture trap 28. The ignition cylinder 24 and the capture trap 28 are stationary elements, while the mixing drum 26, in operation, rotates about the central axis 18.

The ignition cylinder 24 provides the heating source for raising the temperature of the RAP 10 to the desired level for asphalt formation, that being at or slightly below 132° Celsius (two-hundred-seventy degrees Fahrenheit). To accomplish this, the ignition cylinder 24, closed at its upper end, is provided with a fuel injector 30 for delivering combustible fuel 32 (typically natural gas) into the cylinder 24 where an igniter 34 produces flaming gas 36 combining the combustion fuel 32 with pressurized air 38. The pressurized air 38 propels the flaming gas 36 to flow toward the mixing drum 26. A seal ring 40 provides an interface between the stationary ignition cylinder 24 and the rotating mixing drum 26 and prevents the flaming gas 36 from prematurely escaping to the environment or the open interior of the mixing drum 26.

The mixing drum 26 includes a cone segment 42 at its upper end; an elongated cylindrical shell segment 44 for the majority of its length; and an open end 46 which extends into the capture trap 28. The cone segment 42 may either be integrally formed with the mixing drum 26 or else, as in the present embodiment, as separate component securely bonded to the mixing drum 26 so as to mate and rotate therewith.

The cone segment 42 has a tapered tip 48 which extends into the ignition cylinder 24 and a nose cone 49 which deflects flaming gas 36 flow outward and seals the cone segment 42 from the interior of the mixing drum 26. The cone segment 42 further includes gas input ports 50 which allow the flaming gas 36 to flow into a series of radially-spaced longitudinal combustion tubes 52 affixed to the interior surface of the cone segment 42 and the shell segment 44. The nose cone 49 urges the flaming gas 36 to the periphery of the cone segment 42 such that the flaming gas 36 flows only into the combustion tubes 52. The hollow combustion tubes 52 run the entire length of the shell segment 44 and terminate in tube extensions 53 which extend slightly beyond the open end 46 such that spent gases 54 (having the fuel 32 completely consumed during passage so no flame persists) enter the capture trap 28. In the preferred embodiment 14, the combustion tubes 52 in the rearward portions of the cone segment 24 bow outward to enter the larger diameter mixing drum 26. The spaces between the combustion tubes 52 in this segment are open to an enclosing shell—exhaust duct 55 such that the spent gases 54 can escape as described below.

With the exception of the combustion tubes 52 (of which there are twenty equally radially spaced tubes in the preferred embodiment 14) the interior surface of the mixing drum 26 is featureless. There are, however, several features to the exterior.

The mixing drum 26 includes three exterior circumferential ring elements adapted to interface with the support cradle 17 and with a rotational power motor 56 situated in the support cradle 17. A center gear ring 58, situated in about the longitudinal center of the mixing drum 26, interfaces with the rotational motor 56 in order to provide rotational force to spin the mixing drum 26 about the central axis 18 to mix and heat the RAP 10 by conductive energy transfer by contact with the combustion tubes 52 while the RAP 10 gradually gravitationally travels through the mixing drum 26 toward the outflow end 22 and into the capture trap 28. Spaced longitudinally away from the gear ring 58 are a pair of roll rings 60 which interface with the support cradle 17 to support the weight of the APA 14 while facilitating rotation. Except for an intake end portion 62, adjacent to the cone segment 24, and the three circumferential rings, the shell segment 44 of the mixing drum 26 has a uniform solid outer surface throughout its length.

At the intake end portion 62, the mixing drum 26 is provided with a plurality of RAP intake ports 64 for receiving ground RAP 10 from a RAP hopper 66 having a dispensing funnel 68 (typically situated at the uppermost rotational position of the drum 26). The RAP intake ports 64 are equal in number to the combustion tubes 52 and are spaced intermediate the combustion tubes 52 such that RAP 10 delivered through the RAP intake ports 64 falls to the bottom positions of the mixing drum 26, downstream from the cone segment 42, and encounters additional combustion tubes 52. RAP scoops 70, equal in number to the RAP intake ports 64, are situated rearward therefrom such that any spillage of RAP 10 from the dispensing funnel 68 is captured and either urged into a subsequent intake port 64 or delivered to a return bin 72 situated beneath the intake end portion 62 for cycling back to the RAP hopper 66.

The capture trap 28 is aligned with and abuts closely against the open end 46 of the mixing drum 26. The capture trap 28 includes a circular aperture 72 for closely receiving the shell segment 44 while a trap seal ring 74 facilitates a seal between the rotating mixing drum 26 and the stationary capture trap 28. A back wall 76 and a discharge chute 78 direct the renewed amalgam 12 downward.

The tube extensions 53 of the combustion tubes 52 are open ended and extend into the capture trap 28 leaving a space between the tube extensions 53 and the back wall 76 of the trap 28. This allows and propels the spent gases 54 exiting the combustion tubes 52 to be deflected off the back wall 76 and urged to return thorough the mixing drum 26 to make a second pass to provide additional heating to the RAP 10 within the mixing drum 26 before exiting through exhaust ports 57 adjacent to and merging with the RAP intake ports 64. It is noted that a percentage of the spent gas 54 escapes through the shell-exhaust duct 55 at the capture trap 28.

An oil injector pipe 82 extends from the center of the back wall 74 into the mixing drum 26 along the central axis 18 for about 4.6 meters (fifteen feet). The oil injector pipe 82 dispenses oil 84 such that it impacts the heated RAP 10 for the final portion of the passage through the mixing drum and replenishes some of the petroleum content in the RAP 10 in order to form the renewed amalgam 12 by the time it reaches the open end 46 and enters the capture trap 28. Only about one percent of new oil 84 is required in the present invention, as compared to a virgin asphalt process, in order to generate a comparable amalgam.

Once the amalgam 12 finishes its path (propelled by gravity and the rotation of the mixing drum 26) toward the open end 46 of the mixing drum 26 and into the capture trap 28 the amalgam 12 drops between the tube extensions 53 which, as the rotation continues, propel the amalgam 12 upward on the semi-circular inner bottom surface 86 of the trap on into the discharge chute 78. The heated amalgam 12 is then transported by conventional means to holding and dispensing elements so that it may be utilized in paving. [Typically, a truck or other delivery unit will be in place to receive the amalgam 12 before the process is started, so the freshly mixed and heated amalgam 12 is delivered to work sites as expeditiously as possible.]

The process of using the present invention differs from prior art efforts since little or no virgin gravel, sand or oil is utilized. It also differs in that no flaming gases 36 (during combustion) directly encounter the RAP 10 or renewed amalgam 12, since the combustion process is completed within the combustion tubes 52. However, the spent gases 54, still carrying substantial heat from the combustion process, are redirected through the mixing drum 26 in a “second pass”, to add heat transfer to the RAP 10 both from the spent gases 54 and from conduction from the hot surfaces of the metallic combustion tubes. Temperature control is maintained by controlling the fuel mixture 32 with the fuel injector 30 and the air mix and pressure from the pressurized air 38 in the ignition cylinder 24.

In operation, the process of utilizing the asphalt production apparatus (APA) 14 to generate and deliver renewed amalgam 12 utilizing input of predominantly or exclusively RAP 10 as input material involves the following steps:

A. Positioning the APA 14, including the ignition cylinder 24 and the mixing drum 26, in an inclined orientation about a longitudinal central axis 18 from an upper intake end 20 to a lower outflow end 22 where the mixing drum 26 mates with the capture trap 28; B. Initiating rotation of the mixing drum 26 to a predetermined rotation rate and ignite combustion gas 32 in the ignition cylinder 24 to preheat the mixing drum 26 by propelling flaming gas 36 through a series of radially arrayed combustion tubes 52 on the interior surface of the mixing drum 26 until a predetermined optimal temperature is achieved; C. Delivering RAP 10 into the rotating mixing drum 26 by activating a RAP hopper 66 having a dispensing funnel 68 aligned with radially aligned RAP input ports 64 on the mixing drum 26, such that the RAP 10 conductively abuts against successive combustion tubes 52 as the mixing drum 26 rotates and the RAP 10 is gradually propelled by gravity toward the capture trap 28, with additional heating being provides by post-combustion spent gases 54 returned though the mixing drum 26 from the capture trap 24, with a minimal injection of oil 84 in the lower portion of the passage of the RAP 10 downward through the mixing drum 26 to convert the heated RAP 10 into the desired renewed amalgam 12 by the end of the passage; and

D. Collecting the heated renewed amalgam 12 in the capture trap 28, so the rotation of the mixing drum 26 causes the tube extensions 53 to carry the amalgam 12 to the return chute 78 for delivery to transport units for use in paving, while the spent gases 54 are deflected upward by the back wall 76 and forced back through the mixing drum 26 by the pressurized air 38 for a second pass through the drum and to exit via the shell-exhaust duct 55 or, after a second pass, through exhaust ports 57.

The structural components of the APA 14 are primarily constructed of steel while the seal rings 40 and 74 are formed of heat resistant insulating materials to facilitate a sealed buffer intermediate the stationary and rotational components.

The presently preferred embodiment of the APA 14 is constructed of steel and has dimensions as set forth below. The ignition cylinder 24 is 2.44 m (96 in) long and has a diameter of 1.52 m (60 in). The mixing drum 26 is 11.6 m (38 ft.) long and has an outside diameter of 2.34 m (88 in) and an inside diameter of 2.18 m (86 in). The capture trap 28 has a height of 3.0 m (10 ft.), a depth at the bottom of 0.61 m (2 ft.) and the back wall 76 slopes outward to a top depth of 1.83 (6 ft.).

Many modifications to the above embodiment may be made without altering the nature of the invention. The dimensions and shapes of the components and the construction materials may be modified for particular circumstances or types of bags to be carried.

While various embodiments have been described above, it should be understood that they have been presented by way of example only, and not as limitations.

### INDUSTRIAL APPLICABILITY

The asphalt production apparatus (APA) 14 of the present invention is intended for use in producing a renewed amalgam 12 suitable for interchangeable use with virgin asphalt. The core components 16 are specifically adapted for functionality and environmental compatibility, with high percentage, up to including all, of recycled asphalt product (RAP) 10 as raw material. Since RAP 10 is primarily considered as a (substantially) unwanted byproduct of construction projects it is much less expensive and less destructive to the environment to use as the raw material in creating the renewed amalgam 12.

The APA 14 is specifically designed to maintain accurate temperature control to produce consistent renewed amalgam 12 and to accomplish this with less use of combustion fuel 32 since the second pass of the spent gases 54 provides “double-whammy” thermal heating. Additionally the elimination of any contact between flaming gas 36 and the RAP 10 is responsible for avoiding dangerous environmental hazards such as “blue smoke”. This minimizes regulation and administrative costs and makes the process more economical and safe.

For the above, and other, reasons, it is expected that the asphalt production apparatus (APA) 14 and the attendant process of the present invention will have widespread industrial applicability. Therefore, it is expected that the commercial utility of the present invention will be extensive and long lasting.

What is claimed is:

1. A set of core components for an asphalt production apparatus (APA), comprising:
an ignition cylinder having and intake end and an outflow end;
a rotatable mixing drum for mating with a seal separating said ignition cylinder, said mixing drum having at least one intake port to receive at least some recycled asphalt product (RAP) to the interior of said mixing drum, and an open end opposite said ignition cylinder; and
a capture trap mating with said open end, said capture trap receiving renewed amalgam from said mixing drum; wherein
a plurality of longitudinal combustion tubes are arrayed radially on the interior surface of said mixing drum and extend beyond said open end into said capture trap, wherein said combustion tubes receive flaming gas from combustion fuel ignited in said ignition cylinder and are of sufficient length such that combustion of said fuel is completed to spent gases before exiting into said capture trap, and
said combustion tubes extend into said ignition cylinder, beyond said seal with said mixing drum, such that flaming gas is directed only into said combustion chamber such that no burning material enters said mixing drum.

2. The set of core components of claim 1, wherein:
at least some of said spent gases are redirected back through said mixing drum by said capture trap such that said spent gases provide additional heating to said RAP.

3. The set of core components of claim 1, wherein:
a tube extends into said mixing drum to provide oil in order to replenish oil content in said RAP and to facilitate conversion into said renewed amalgam.

4. The set of core components of claim 1, wherein:
said input ports are adapted to receive a mixture of virgin asphalt and RAP.

5. The set of core components of claim 4, wherein:
said mixture of virgin asphalt and RAP is at least thirty-five percent RAP.

6. The set of core components of claim 1, wherein:
the exterior surface of said mixing drum includes a plurality of exhaust ports near its upper end to vent spent gases returned trough said mixing drum in a second pass.

7. A method for preparing renewed amalgam asphalt from recycled asphalt product (RAP), in steps, which need not be in precise order in all cases, comprising
A. Positioning the core components of the asphalt production apparatus (APA), comprising an ignition cylinder, a mixing drum, and a capture trap, in an aligned inclined orientation about a longitudinal central axis from an upper intake end to a lower outflow end where said mixing drum mates with said capture trap;
B. Initiating rotation of said mixing drum to a predetermined rotation rate and igniting combustion fuel in said ignition cylinder to preheat said mixing drum by propelling flaming gas through a series of radially arrayed combustion tubes on the interior surface of said mixing drum until a predetermined optimal temperature is achieved;
C. Delivering crushed recycled asphalt product (RAP) into said rotating mixing drum by activating a RAP hopper having a dispensing funnel aligned with radially aligned RAP input ports on said mixing drum, such that said RAP conductively abuts against successive combustion tubes as said mixing drum rotates and the RAP is gradually propelled by gravity toward said capture trap, with additional heating being provides by post-combustion spent gases returned though said mixing drum from said capture trap, with a minimal injection of oil in the lower portion of the passage of the RAP downward through said mixing drum to convert the heated RAP into the desired renewed amalgam by the end of the passage; and
D. Collecting the heated renewed amalgam in said capture trap, such that the rotation of said mixing drum causes tube extensions extending from said combustion tubes into said capture trap to carry said amalgam to a return chute for delivery to transport units for use in paving, while at least some of said spent gases are deflected upward by a back wall of said capture trap and forced back through said mixing drum for a second pass through said mixing drum and to exit via a plurality of exhaust ports.

8. The method of claim 7, wherein:
the rotation of said mixing drum causes said virgin asphalt and RAP mixture to cascade over a plurality of said combustion tubes so as be heated by thermal conduction.

9. The method of claim 7, wherein:
the internal temperature of said mixing drum is maintained below the threshold of provision of blue smoke contamination.

10. The method of claim 7, wherein:
the angle of declension said central axis is about five degrees.

11. An asphalt production apparatus (APA) adapted to utilize a significant material percentage of recycled asphalt product (RAP) while avoiding flaming gas contact with input materials, comprising:
input means for delivering raw materials, including RAP, combustible fuel, and air;
an ignition chamber for igniting said fuel into flaming gas;
an inclined rotating mixing drum having a central shell segment for receiving RAP and raw materials, said mixing drum having a plurality of radially spaced hollow combustion tubes for mating with said combustion chamber, said combustion tubes extending longitudinally about the interior of said shell segment, with said combustion tubes being isolated from the interior of said shell segment for the length thereof; and
a capture trap extending beyond the lower end of said mixing drum to receive and dispense renewed amalgam from said mixing drum; wherein
said flaming gas is driven into and through said combustion tubes to heat said combustion tubes for delivering thermal energy conductively to said RAP at a rate that flaming gas is consumed therewithin and only spent gases reach said capture trap.

12. The APA of claim 11, wherein
said capture trap is configured such that at least some spent gases are redirected back through said mixing drum in a second pass to provide additional heat to the interior of said shell segment.
